(19) United States
(12) Patent Application Publication
(10) Pub. No.: US 2023/0315778 A1
(43) Pub. Date: Oct. 5, 2023

(54) SYSTEM FOR HAVING VIRTUAL CONVERSATIONS WITH DECEASED PEOPLE

(71) Applicant: 1000125991 ONTARIO CORPORATION, Ottawa (CA)

(72) Inventor: Emily Katharine Louise CROCCO, Ottawa (CA)

(21) Appl. No.: 18/126,180

(22) Filed: Mar. 24, 2023

Related U.S. Application Data
(60) Provisional application No. 63/326,663, filed on Apr. 1, 2022.

(51) Int. Cl. G06F 16/45

(52) U.S. Cl. CPC G06F 16/45

(57) ABSTRACT

A system allows a person to interact with a virtual representation of another person. The person may be a family member or someone famous, who may be alive or deceased. The system and methods allow a person to record or input sufficient information to allow for a later static, interactive or virtual playback by someone else. Embodiments provide for the processing, tagging, and categorization of recorded data as well as the storage, processing, and modification of recorded information for later use. Recorded data is used to generate an interactive model of the person being recorded. Authorized people can later interact with and have virtual conversations, even relationships, with the interactive model using a variety of means.

### CROSS REFERENCE TO RELATED APPLICATIONS

This application claims the benefit of priority to U.S. provisional patent application Ser. No. 63/326,663 entitled “SYSTEM FOR HAVING VIRTUAL CONVERSATIONS WITH DECEASED PEOPLE” filed Apr. 1, 2022, hereby incorporated by reference in its entirety.

### FIELD OF THE INVENTION

The present invention pertains to the field of the preservation of audio/visual (AV) and written information of a person, and in particular to the use of archived AV information to recreate a digital representation of a person at a later time for use in virtual interactions with future generations.

### BACKGROUND

It is a basic human need to find out where we came from. There exists a widespread interest in genealogy and history to try to know our ancestors and the people who lived before us. Many people are curious and wonder how historical people, whether related or not, thought and made decisions.

To meet this need, there exists many solutions to record basic information concerning our ancestors. In the past, details might be noted in a family bible, in a family tree, in diaries, or through oral traditions.

Presently, there are many technological ways of commemorating people and events, particular through audio and video recordings, many of which are posted on social media forums and elsewhere. Compared to earlier methods of record-keeping, computer-based platforms provide increased flexibility in recording and preserving information.

However, present day solutions have continued limited value in that they only provide a static perspective of a person. The manner in which data is recorded and used is inadequate to produce an interactive, realistic representation of a person.

Therefore, there is a need for improved systems and methods that better capture a person's personality and allow for an interaction with a representation of the person that obviates or mitigates the one or more limitations of the prior art.

This background information is provided to reveal information believed by the applicant to be of possible relevance to the present invention. No admission is intended, nor should be construed, that any of the preceding information constitutes prior art against the present invention.

### SUMMARY

An object of embodiment of the present invention is to provide methods and systems that allow a person to interact with a virtual representation of another person. The virtually represented person may be a family member or not, who may or may not be deceased.

Embodiments provide a way for future generations (whether related or not) to have meaningful conversations with people who have passed away. As used herein, “meaningful” refers to the types of conversations where future people share the important events of their lives, ask for and receive advice or affirmations, are listened to intently, and who are able to express themselves openly. In these conversations, the listener (the deceased person's avatar), would respond in a way that genuinely recreates the unique elements of the deceased person's personality.

Embodiments will make it possible for people to continue to have relationships with people who have passed away and in these and other ways, to feel seen and heard while learning from the deceased person's experiences.

The use of embodiment by future generations will itself allow the embodiments themselves to develop. As more content is shared by past and current participants, embodiments may become smarter in terms of how to capture and reflect the elements of personality and how to mimic the kinds of relationships (business; family; friendships; lovers, even) that people might have had with the deceased. If what defines and strengthens a relationship is communication, then embodiments will allow future participants to have relationships with past participants, as embodiments will have captured the triggers and elements of the deceased's′ manners of communication.

Embodiments include methods and systems to allow a person to record sufficient information to allow for an interactive playback or virtual conversation at a later time. Embodiments provide for the processing, tagging, and categorization of recorded data as well as the storage, processing, and modification of recorded information for later use. Recorded data is used to generate an interactive model of the person being recorded. Authorized people can interact with and have a virtual interaction, and especially, a conversation, with the interactive model at a later date using a variety of means. Embodiments also provide controls on who can interact with a recording, and these may be based on factors such as relationship, time, events, and the payment of fees.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 provides an illustration of a system for recording information for providing a virtual conversation, according to an embodiment.

FIG. 2 provides a data model of how inputs may be categorized, have attributes assigned, and be stored for later use, according to an embodiment.

FIG. 3 provides an illustration of a method to allow a user of the system to access the system and interact with a virtual conversation, according to an embodiment.

FIG. 4 provides a security model to restrict access to the system unless authorized, according to an embodiment.

FIG. 5 provides an illustration of a model of factors used in creating an avatar for use in a virtual conversation, according to an embodiment.

FIG. 6 provides a schematic diagram of an electronic device that may perform any or all of operations of the above methods and features, explicitly or implicitly described herein, according to different embodiments of the present invention.

It will be noted that throughout the appended drawings, like features are identified by like reference numerals.

### DETAILED DESCRIPTION

Embodiments will now be described with reference to the figures. For simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

An object of embodiment of the present invention is to provide methods and systems that allow a person to interact with a virtual representation of a person. The person may be a family member, who may be deceased, or anyone of some interest to a future generation (whether as researcher, writer, creator, learner, teacher, investor, or member of the general public).

Embodiments include methods and systems to allow a person to record sufficient information to allow for an interactive playback at a later time. Embodiments provide for the processing, tagging, and categorization of recorded data as well as the storage and processing of recorded information for later use. Recorded data is used to generate an interactive model of the person being recorded. Authorized people can interact with and have a virtual conversation with the interactive model at a later date using a variety of means.

Embodiments also provide controls on who can interact with a recording based on factors such as relationship, time, events, and the payment of fees.

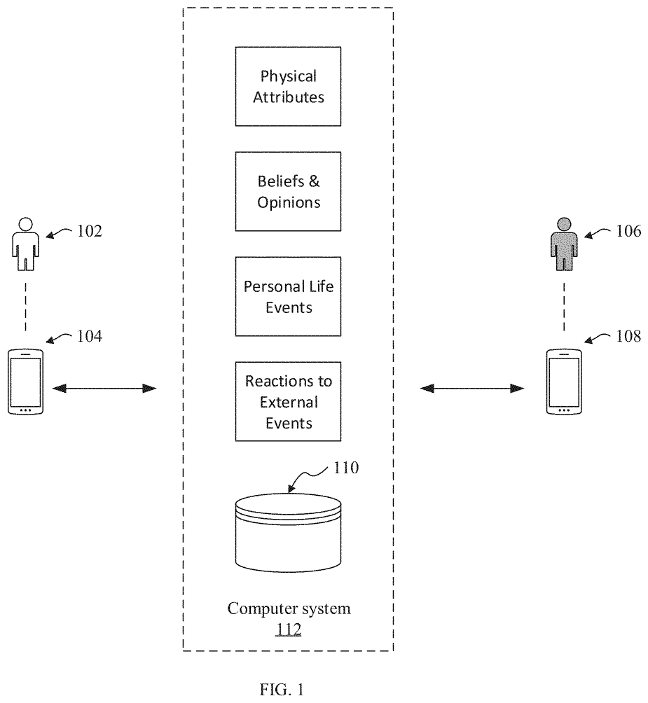

FIG. 1 provides an illustration of a system for recording information for providing a virtual conversation, according to an embodiment. A contributor 102, a person wanting to contribute audio/visual recordings and other information in order to create a digital legacy, has access to one or more computing devices, such as a cellular phone, tablet, personal computer, kiosk, etc. Computing devices may be equipped with human interface devices such as a camera, microphone, etc., as well as body monitoring devices such as a heart rate monitor, blood pressure monitor, etc., that may be used to determine the contributor's 102 physical and emotional state while making a recording. Computing devices may be used to record audio/visual files capturing the contributor's feedback in response to prompts by the computing system or when initiated by the contributor 102 or another person. Computing devices may also be used to capture, store, or upload any number and type of computer files as desired by the contributor 102 or a person acting on their behalf. This may include photos, audio files, video files, scanned documents, digitized physical documents, archived online material, links to online material, etc. In summary, reference is made to any digital file or document that should be included in the contributor's 102 digital legacy.

In embodiments, the contributor 102 may be a long dead person for whom there exists sufficient archival data such as film clips, audio clips, writings, etc., to produce a sufficiently realistic avatar and conversational data.

Digital files, including A/V recordings, are processed by computer system 112 to extract personality and contextual data as they apply to the contributor 102. This may include identifying physical and psychological attributes, beliefs, and opinions, associating the digital files with personal life events of the contributor 102, reactions of the contributor 102 to external events, etc. The processing allows the computer system to create the basis for virtual conversations between the contributor 102 and a user 106 who later may engage in a virtual conversation with a realistic avatar of the contributor 102.

User 106 also has access to their computing device 108, which may be any of the same types of digital devices that the contributor 102 has used. In addition, user 108 may be several people or an audience. Embodiments include the case of a single user 108 having a virtual conversation with a contributor 102 and also include the case of a large number of users 108 having a virtual conversation with a contributor 102 who is a famous person in a large venue such as a physical theatre or a virtual meeting arena.

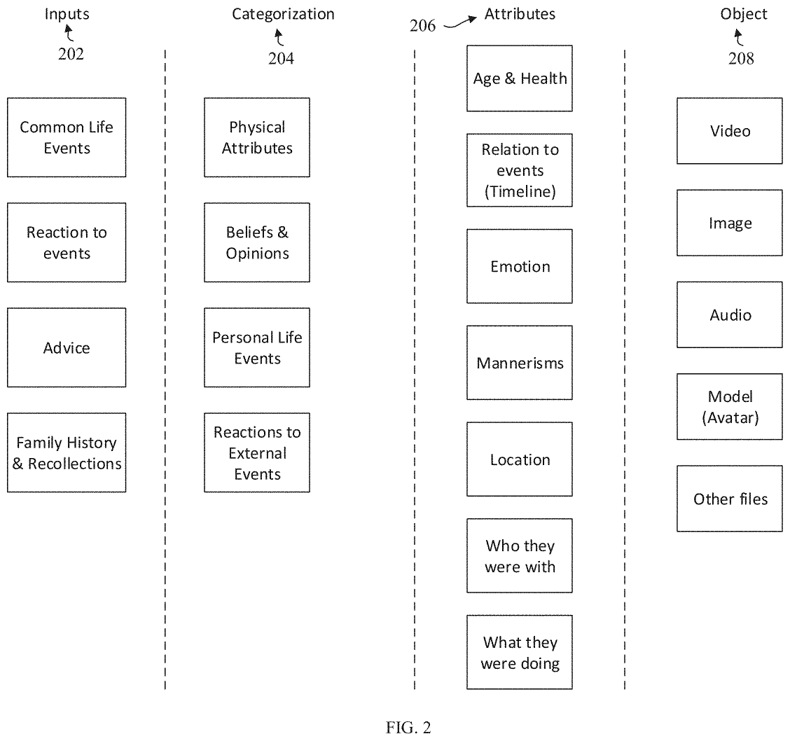

FIG. 2 provides a data model of how inputs may be categorized, have attributes assigned, and be stored for later use, according to an embodiment. A contributor 102 may create, upload, or submit digital files on their own initiative or may be prompted using a structured method to contribute the file. Each digital file may be left as uploaded or may be broken up into smaller segments. Segments may overlap in time. Each file or segment becomes a contribution and is classified and stored to enable the system to produce a model or avatar of the contributor 102 and to provide information for generating a virtual conversation at a later time. Segments may apply to any digital file. An audio or video file may be divided into clips with a start time and duration. A text file may be divided into words, sentences, or paragraphs. A scanned document or photo may be cropped, rotated, or enhanced to show a particular aspect of the contributor 102.

In embodiments, contributions may be broadly associated with different categories including physical attributes of the contributor 102, beliefs & opinions of the contributor 102, personal life events of the contributor 102, and the contributor 102's reactions to external events. Examples of physical attributes may be related to the contributor's 102 height, weight, hair, mannerisms (especially eye and mouth movements), way of speaking (especially regarding volume, pace, and use of idioms), movements while speaking, use of gestures during speaking, ways of walking, running, etc. Examples of beliefs and opinions may include the contributor 102 speaking or writing about a wide variety of things from religion to ethics, politics, parents, relatives, siblings, to their favourite breed of dog or their favourite pizza toppings.

Personal life events may include the contributor 102 speaking or writing about life events such as their first day at school, high school graduation, getting married, the death of a loved one, how they handled success or failure (for example in friendships, relationships, or at work), what they would have done the same or differently, and especially advice for the user 106 in any of the remarkable or mundane aspects of life. Reactions to external events can include the contributor 102 speaking or writing about important or mundane events such as the first man on the moon or the fall of the Berlin Wall, to a big snowfall or a teacher's strike when they were in elementary school.

The contributor 102 may also watch a movie or listen to music or otherwise be exposed to external prompts and their data be observed during the event to digitize values and personality.

All of these categories are from the point of view of the contributor 102 and will vary from person to person and be very dependent on their individual life experiences and values, personalities, and physical characteristics.

In embodiments, file segments may also have attributes assigned to them. Attributes build on categories to describe the information that is contained in each file segment. Examples of attributes include age and health, relation to events, emotion, mannerisms, location, who the contributor was with, what they contributor was doing at the time, etc. Age and health attributes may be used to demonstrate the age and health of the contributor 102 when the recording was made or at any other moment in their life. This can include segments that demonstrate the contributor's condition, or it can include segments where the contributor 102 is speaking, writing, or otherwise demonstrating their condition at a particular point in time. Relation to events attributes can show or demonstrate the contributor's physical or mental condition in relation to a personal or external event. An example is how the contributor looked or felt on their wedding day or when other significant events occurred. Emotion attributes are used to indicate file segments that show emotion of contributor 102. Similarly, mannerisms attributes are used to indicate file segments that demonstrate mannerisms of a contributor 102. Mannerisms may include physical mannerisms such as blinking or the use of hand gestures while speaking. Mannerisms may also include speech patterns such as pausing or stuttering. Location attributes are used to associate a file segment with a location. Similarly, attributes may be used to tag who the contributor was with at a time associated with the file segment.

In embodiments, file segments may also be tagged as to their contents including video, image, audio, model or avatar data, and other files as needed. File segments that are of the same type of object, such as video files, may be converted to a common format before storing them for processing and retrieval.

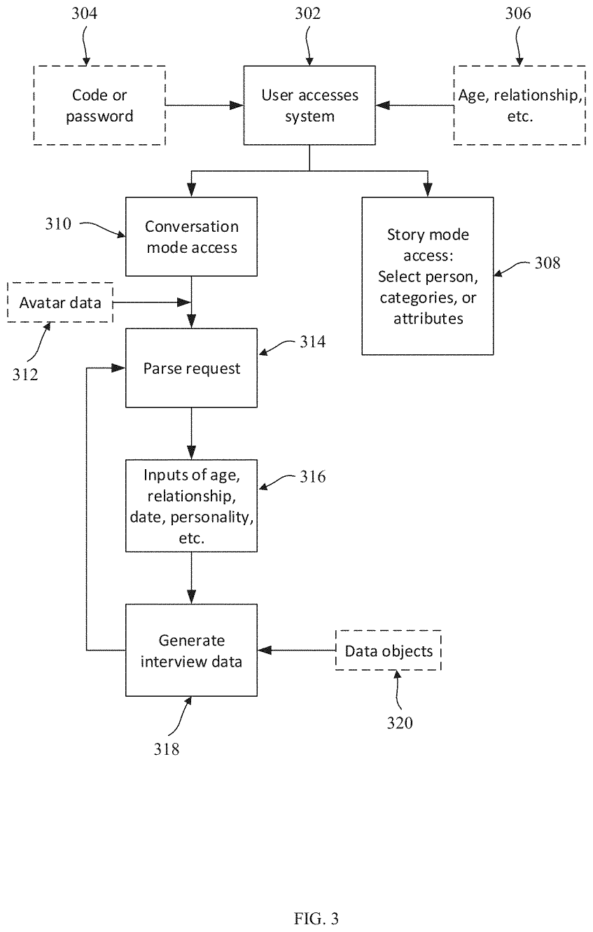

FIG. 3 provides an illustration of a method to allow a user of the system to access the system and interact with a virtual conversation, according to an embodiment. A user 106 desires to access the system 112 to engage in a virtual conversation with an avatar of contributor 102. User 106 accesses a user access system 302, which may be integrated into computer system 112 or be a separate system in communication with computer system 112. In embodiments, user 106 may have received a user access code or password 304 which may have been received directly or indirectly from contributor 102. For example, a contributor 102 may bequeath access codes to their heirs in a will or to those who will pay for interactions with them. In other cases, a person belonging to an organization may receive an access code from the organization or for being part of an organization. In some cases, access codes may not be required at all. Access may be restricted based on a number of criteria 306 such as age, relationship, purchase agreement, etc. For example, some content may be restricted only to a spouse or partner, to children, to family, or to a payee. Access may be limited or different depending on the age of a user 106. For example, a contributor 102 who experienced and shares their experiences relating to trauma due to war or other abuse may have different content or content control for children and adults. A contributor 102 may also describe the event, and their avatar may converse, differently with known family members, unknown descendants, and other specified or general audiences. Different access and descriptions may be recorded separately by a contributor 102 or may be generated automatically by the user access system 302 based on the access type or level, or the characteristics (age, relationship, etc.) of the user 106.

In embodiments, once access is granted and access parameters are determined, a user 106 may have several options for how they interact with the user access system 302. One option, referred to as a story mode access 308, allows user 106 to select virtual conversation topics from a selection, for example from a menu, or by using a search function. Using this access mode, a user 106 may select a person (contributor 102) and then categories 204, attributes 206, or other criteria to access digital recordings or virtual embodiments thereof. For example, they may select their grandmother's name and then a “wedding day” event. Alternatively, a user 106 may utilize a conversation mode access 310 to participate in an unstructured or structured simulated conversation with an avatar of a contributor 102 (within this, there could be various modes, including, for example, listening and debating modes). Once a user 106 accesses the user access system 302 and initiates conversation mode access 310, they select a contributor 102 to which they have access and avatar data 312 for that contributor 102 is loaded. User 106 inputs a request which is parsed 314 by the system. Requests may be entered by any number of means including by voice, touch, typing, writing, gesture, etc. User access system 302 takes the request as well as inputs 316 of information or parameters such as age, relationship, date, personality, etc. of the user 106 or the contributor 102 and uses this to generate conversation data 318 using relevant data objects 320 to generate an avatar. An avatar may include both audio and visual data as required to display a digital representation of the contributor 102 and the contents of a realistic conversation for user 106.

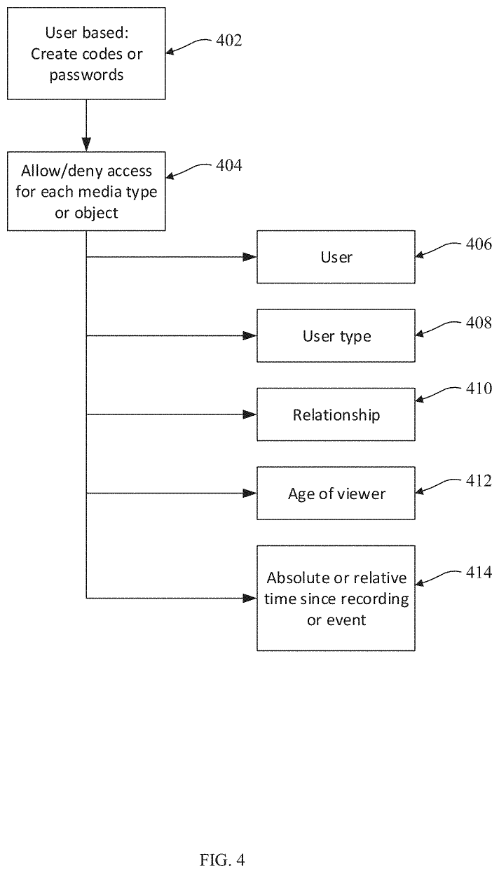

FIG. 4 provides a security model to restrict access to the system unless authorized, according to an embodiment. User or group based codes and passwords 402 may be created and distributed that allow or deny access to a virtual conversation based on a number of criteria including media type (as defined by categorization 204, attributes 206, object type 208, etc.). Allowance or denial may be based on a number of criteria including on a per user basis 406, on a user type or category 408, relationship 410 (such as close family, extended family, neighbour, co-worker, membership in an organization, etc.), age of viewer or user 412, an absolute or relative time 414 since recording or since an event described in a recording, or the payment of fees.

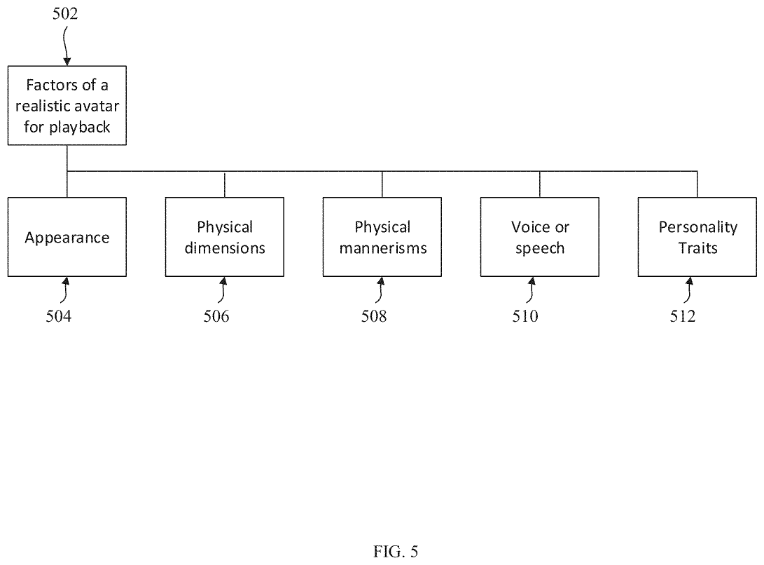

FIG. 5 provides an illustration of a model of factors used in creating an avatar for use in a virtual conversation, according to an embodiment. A virtual conversation is preferably a synthesized video or reproduction of the contributor 102 with realistic look, voice, speech patterns, language, mannerisms, etc. providing a high level of realism. However, the virtual conversation may also be limited to audio, similar to a simulated telephone conversation, or to text, as in a simulated letter or typed conversation, to the user 106. Computing system 112 will generate an appropriate avatar taking into account factors such as the appearance 504 of the contributor (including a simulated age), physical dimensions 506 (height, width, weight, etc.), physical mannerisms 508 (stutters, use of hands while speaking, looking straight at you or not, etc.), voice 510 (a realistic simulated voice, language, dialect, vocabulary, and vocal patterns of the contributor 102), and other personality traits 512.

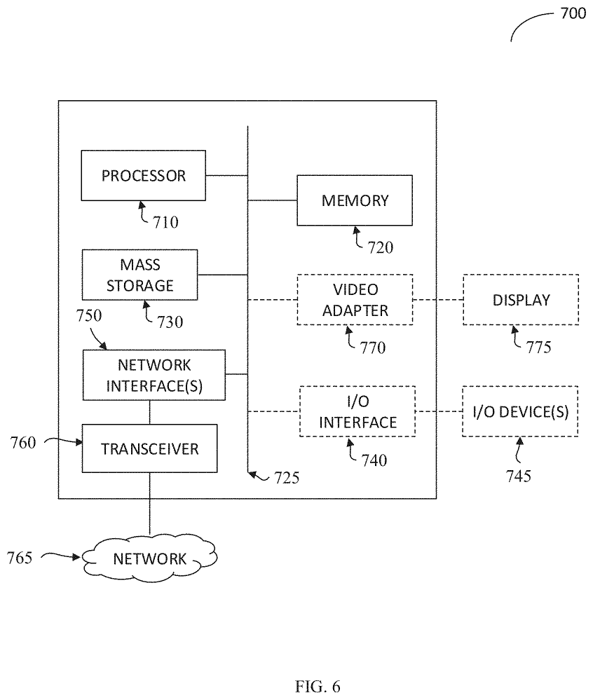

FIG. 6 is a schematic diagram of an electronic device 700 that may perform any or all of operations of the above methods and features explicitly or implicitly described herein, according to different embodiments of the present invention. For example, a mobile computing device, a physical or virtual computer or server may be configured as computing device 700.

As shown, the device includes a processor 710, such as a central processing unit (CPU) or specialized processors such as a graphics processing unit (GPU) or other such processor unit, memory 720, non-transitory mass storage 730, I/O interface 740, network interface 750, video adaptor 770, and any required transceivers 760, all of which are communicatively coupled via bi-bus 725. Video adapter 770 may be connected to one or more of display 775 and I/O interface 740 may be connected to one or more of I/O device 745 which may be used to implement a user interface. According to certain embodiments, any or all of the depicted elements may be utilized, or only a subset of the elements. Further, computing devices 700 may contain multiple instances of certain elements, such as multiple processors, memories, or transceivers. Also, elements of the hardware device may be directly coupled to other elements without the bus 725. Additionally, or alternatively to a processor and memory, other electronics, such as integrated circuits, may be employed for performing the required logical operations.

The memory 720 may include any type of non-transitory memory such as static random-access memory (SRAM), dynamic random-access memory (DRAM), synchronous DRAM (SDRAM), read-only memory (ROM), any combination of such, or the like. The mass storage element 530 may include any type of non-transitory storage device, such as a solid-state drive, hard disk drive, a magnetic disk drive, an optical disk drive, USB drive, or any computer program product configured to store data and machine executable program code. According to certain embodiments, the memory 720 or mass storage 730 may have recorded thereon statements and instructions executable by the processor 710 for performing any of the aforementioned method operations described above.

It will be appreciated that it is within the scope of the technology to provide a computer program product or program element, or a program storage or memory device such as a magnetic or optical wire, tape or disc, USB stick, file, or the like, for storing and interpreting signals readable by a machine, for controlling the operation of a computer according to the method of the technology and/or to structure some or all of its components in accordance with the system of the technology. Acts associated with the method described herein can be implemented as coded instructions in a computer program product. In other words, the computer program product is a computer-readable medium upon which software code is recorded to execute the method when the computer program product is loaded into memory and executed on the microprocessor of computing devices.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations, or equivalents that fall within the scope of the present invention.

What is claimed is:

1. A method for recording information from a contributor, the method comprising:
recording an audio/visual digital file;
dividing the digital file into at least one segment based on a category and an attribute, wherein the category is based on a classification of the segment and the attribute is based on a quality of the contributor; and
storing the segment.

2. The method of claim 1 wherein the classification is a physical or personality attribute of the contributor and further comprising creating an avatar of the contributor based on the segment.

3. The method of claim 2 wherein the attribute includes a representation of age or health, a mannerism, physical composition, an emotion, or other personality trait.

4. The method of claim 3, wherein a user conducts a virtual conversation with an avatar of a contributor, and comprises:
inputting, by the user, an audio or other request to a computing system;
parsing, by the computing system, the audio or other request into a segment based on a category and an attribute, wherein the category is based on a classification of the segment and the attribute is based on a quality of the contributor;
retrieving a recorded digital segment based on the category and the attribute; and
initiating and conducting the virtual conversation with the contributor's avatar, based on the recorded digital segment and data received in response to the recorded or virtual digital segments.
